(19) United States
(12) Patent Application Publication
(10) Pub. No.: US 2026/0258759 A1
(43) Pub. Date: Sep. 3, 2026

(54) METHOD FOR CORRECTING AN ANGULAR POSITION MEASUREMENT IN AN INTERNAL COMBUSTION ENGINE

(71) Applicant: VITESCO TECHNOLOGIES GmbH, Regensburg (DE)

(72) Inventor: Xavier MOINE, Toulouse (FR)

(73) Assignee: VITESCO TECHNOLOGIES GmbH, Regensburg (DE)

(21) Appl. No.: 18/881,910

(22) PCT Filed: Jul. 28, 2023
(86) PCT No.: PCT/EP2023/070962

§ 371 Date: Jan. 7, 2025

(30) Foreign Application Priority Data
Aug. 4, 2022 (FR) FR2208086

(51) Int. Cl. F02D 41/00

(52) U.S. Cl. CPC F02D 41/009

(57) ABSTRACT

A method for determining the angular position of an engine, including the following steps: detection of a first mode of operation of the engine; measurement of a first time elapsed between the passing of a tooth front that passes before the combustion tooth front, and that is referred to as earlier tooth front, and of the combustion tooth front; measurement of a second time elapsed between the passing of the combustion tooth front and of a tooth front that passes after the combustion tooth front and that is referred to as a later tooth front, comparison of the first time with the second time; and determination of a corrective term for the angular position measurement measured by the sensor on the basis of the result of the comparison of the first time with the second time.

### CROSS REFERENCE TO RELATED APPLICATIONS

This application is the U.S. National Phase Application of PCT International Application No. PCT/EP2023/070962, filed Jul. 28, 2023, which claims priority to French Patent Application No. FR2208086, filed Aug. 4, 2022, the contents of such applications being incorporated by reference herein.

### FIELD OF THE INVENTION

The present disclosure relates to a method for correcting an angular position measurement in an internal combustion engine.

The technical field of the present invention is thus the field of engine control for an internal combustion engine. The present disclosure is intended notably for a motor vehicle or similar (motorcycle, truck, etc.) but can also be used for another application of an engine (mower or other mobile power tool, static engine, etc.).

### BACKGROUND OF THE INVENTION

In an internal combustion engine, at least one piston slides in a reciprocating back and forth movement in a cylinder, thus delimiting a variable-volume combustion chamber. A linkage converts this translational movement into a rotational movement. The position of each piston in its cylinder is determined on the basis of the angular position of a flywheel. This angular position is determined in a way known to those skilled in the art and not detailed here, using a position sensor associated with a toothset created at the periphery of the flywheel. Knowing the position of each piston in its cylinder makes it possible to manage the operation of the engine and notably to determine the moment (or angular position of the flywheel) at which fuel needs to be injected into a cylinder.

The use of the position sensor makes it possible to know the angular position of an engine each time a tooth front (rising front or falling front or both) of a tooth of the toothset passes past the position sensor. However, the position indicated by the sensor is accurate only to within a few degrees (for example 2 to 3°). The reason for this is the manufacturing tolerances, notably on the toothset and on the positioning of the position sensor with respect to this toothset.

This accuracy is sufficient for good engine management in accordance with the current legislation. However, in order to achieve more refined management of the engine, and notably of the injection of the fuel, and possibly of a command to ignite the injected fuel, it is desirable to obtain an accuracy of within 1° if possible. The technical problem of better determining the position of the pistons of an engine may affect controlled-ignition engines, compression-ignition engines, and more particularly, although not exclusively, engines referred to as four-stroke engines.

### SUMMARY OF THE INVENTION

The present disclosure is intended to improve the situation. It is notably intended to provide a solution for determining the angular position of an engine with greater accuracy using the sensors generally present in an engine, overcoming the effect of the tolerances on the mounting of said sensors and on the machining of a target bearing an associated toothset. As a preference, this method will make it possible to obtain greater accuracy without the need to modify the target and/or the sensor that are used for performing the position measurement. Moreover, advantageously, implementing this method will not require the use of new components in an engine.

What is proposed is a method for determining the angular position of an internal combustion engine, wherein a measurement of the angular position is made using a target comprising at its periphery uniformly spaced teeth with one singularity and which is associated with a sensor that detects the passage of a tooth front for each tooth, a passage past a tooth front theoretically corresponding in the engine to the passing of a predetermined piston through a top dead center position at the end of the compression stroke in a corresponding cylinder, said tooth front being referred to hereinafter as a combustion tooth front.

According to the present disclosure, it is proposed that said method comprise the following steps:
detection of a first predetermined mode of operation of the engine;
measurement of a first time elapsed between the passing past the sensor of a tooth front that passes before the combustion tooth front, and that is referred to as earlier tooth front, and of the combustion tooth front;
measurement of a second time elapsed between the passing past the sensor of the combustion tooth front and of a tooth front that passes after the combustion tooth front and that is referred to as a later tooth front, the later tooth front being symmetrical with the earlier tooth front about the combustion tooth front;
comparison of the first time with the second time, these two times being theoretically equal if the combustion tooth front passes past the sensor when the predetermined piston is passing through its top dead center position at the end of the compression stroke; and
determination of a first corrective term for the angular position measurement measured by the sensor on the basis of the result of the comparison between the first time and the second time according to a predetermined formula corresponding to an engine type.

This method makes it possible to determine whether the true top dead center position is properly centered with respect to the measurements taken. This method first of all makes it possible to identify misalignment between the sensor and the target.

The features set out in the following paragraphs can optionally be implemented independently of one another or in combination with one another:
the first predetermined mode of operation of the engine corresponds to the engine operating at low idle;
the earlier tooth front corresponds to the tooth front immediately preceding the combustion tooth front and the later tooth front corresponds to the tooth front immediately following the combustion tooth front.

According to a first variant of this method for determining the angular position of an internal combustion engine, the comparison between the first time and the second time corresponds to a difference, the value of the difference is filtered in order to yield a filtered difference, and the first corrective term corresponds to an affine function of the filtered difference.

This first variant relates more particularly to an irregular-ignition engine, and the method according to this first variant may further comprise the following steps:
measurement of a third time elapsed between the passing past the sensor of the tooth front that passes one revolution, namely 360°, after the earlier tooth front, and of the tooth front one revolution after the combustion tooth front;
measurement of a fourth time elapsed between the passing past the sensor of the tooth front that passes one revolution after the combustion tooth front and of the tooth front that passes one revolution after the later tooth front;
determination of a second corrective term for the angular position measurement measured by the sensor on the basis of the result of the comparison between the third time and the fourth time according to a predetermined formula corresponding to an engine type.

What is referred to here as an irregular-ignition engine is any engine for which a position 360° C. RK after one combustion top dead center position does not correspond to combustion in a cylinder of said engine. An irregular-ignition engine is thus, for example, a single-cylinder four-stroke engine or a three-cylinder or five-cylinder engine in which ignition is evenly distributed over the 720° (of a four-stroke engine). Two-stroke engines are not included here.

In this first variant, provision may also be made for the comparison between the third time and the fourth time to correspond to a difference, for the value of the difference to be filtered in order to yield a filtered difference, and for the second corrective term to correspond to an affine function of the filtered difference.

According to a second variant of the method for determining the angular position of an internal combustion engine. This variant is intended for any type of internal combustion engine, two-stroke or four-stroke, irregular or otherwise.

According to this second variant, what is proposed is for the comparison of the first time with the second time to be a calculation of a first ratio corresponding to the ratio linking the second time and the first time;
and for the method to further comprise the following steps:
detection of a second predetermined mode of operation of the engine;
measurement of a third time elapsed between the passing past the sensor of a tooth front that passes before the combustion tooth front, and that is referred to as earlier tooth front, and of the combustion tooth front;
measurement of a fourth time elapsed between the passing past the sensor of the combustion tooth front and of a tooth front that passes after the combustion tooth front and that is referred to as a later tooth front, the later tooth front being symmetrical with the earlier tooth front about the combustion tooth front;
comparison of the third time with the fourth time by calculating a second ratio corresponding to the ratio linking the fourth time and the third time; and
determination of the first corrective term for the angular position measurement measured by the sensor on the basis of the ratio linking the first ratio and the second ratio according to a predetermined formula corresponding to an engine type.

In this second variant, provision may also be made for the second predetermined mode of operation of the engine to correspond to operation at high engine speed, which is to say an engine speed above a predetermined speed, and at light load, namely at a load lower than a predetermined load.

According to another aspect, a computer program is proposed comprising instructions for implementing a method as described hereinabove when this program is executed by a processor, notably an electronic control unit of an internal combustion engine.

According to another aspect, a non-transitory computer-readable recording medium, on which such a program is recorded, is proposed.

### BRIEF DESCRIPTION OF THE DRAWINGS

Other features, details and advantages will emerge upon reading the following detailed description and from examining the appended drawings, in which:

FIG. 1

FIG. 1 shows variations in the torque of an engine over the course of time.

FIG. 2

FIG. 2 shows a logic diagram for the implementation of a method according to the present disclosure.

### DETAILED DESCRIPTION OF EXEMPLARY EMBODIMENTS

The present disclosure relates to a configuration known to those skilled in the art, whereby the angular position of an internal combustion engine is determined on the basis of a target equipped with teeth and of a corresponding position sensor. It is assumed here that this engine operates on a four-stroke cycle, namely that a piston reciprocates back and forth twice per one combustion cycle (intake, compression, power and exhaust). This piston is connected by a connecting rod to a crankshaft. The flywheel is firmly attached to the crankshaft and therefore executes two revolutions, namely a rotation through 720°, per one combustion cycle. This flywheel is equipped at its periphery with teeth, and thus forms the aforesaid target. Each tooth has a corresponding adjacent tooth gap. The periphery of the flywheel is therefore divided into N uniformly distributed sectors, each sector comprising one tooth and one adjacent tooth gap. However, in order to create a reference R on the flywheel, at least one tooth is eliminated. There are thus (N-i) teeth at the periphery of the flywheel, with an angular offset of (360/N°) between two successive teeth, except of course at the reference R. The sensor associated with the flywheel detects the passing of each tooth. It is (and this list is not exhaustive) a variable-reluctance sensor or else a Hall-effect sensor. However, as is known, just one tooth front is detected. It is assumed by way of example that the sensor detects the falling fronts, which is to say the passes past the sensor of a tooth leading to a tooth gap as the flywheel rotates. Thus, in the remainder of the description, where mention is made of a tooth front this is a tooth front detected by the sensor, namely, in the assumption made here, a falling tooth front.

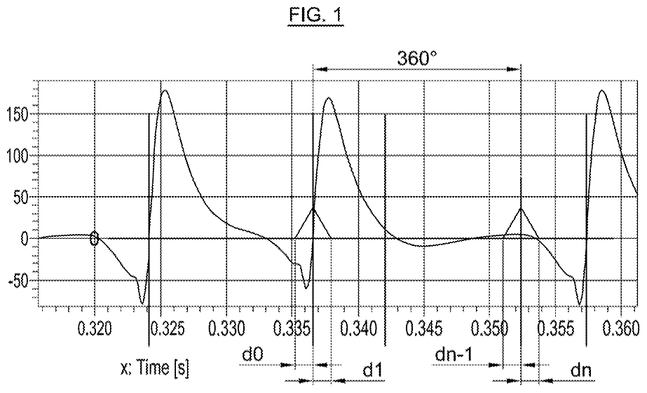

It is also assumed here that the engine considered purely by way of nonlimiting illustration is a two-cylinder engine with its two cylinders in a 90° V. In such a scenario, each of the two pistons passes through its top dead center (TDC) position once during a combustion cycle. Only the top dead center position that follows a compression phase, namely the top dead center position around which fuel is injected, is considered here as being a top dead center position. By numbering the two cylinders 0 and 1, there are then two top dead center positions, TDC0 and TDC1. It is assumed here that the flywheel is mounted on the crankshaft in such a way that each top dead center position TDC1 coincides with the falling flank of a tooth. In this scenario (a two-cylinder engine with the cylinders in a 90° V), the top dead center positions are not uniformly distributed over an engine cycle of 720° C. RK. Between one top dead center position TDC0 and the next top dead center position TDC1, there is a separation of 270° C. RK, and between one top dead center position TDC1 and the next top dead center position TDC0 there are 450° C. RK (FIG. 1).

Despite the great deal of care taken when machining the target and positioning the sensor with respect to the target, there are inevitably manufacturing tolerances which mean that there is an offset between the true engine position (in° CRK) and the position measured by the sensor. Thus, for example, when passing through a top dead center position, the tooth front that theoretically faces the sensor and that is theoretically detected during this passage through top dead center, is slightly offset with respect to the sensor. The measurement accuracy is usually of the order of 2 or 3° C. RK.

This error in the measurement has an influence on the performance of the engine. For example, for a controlled-ignition engine, the ignition command is triggered with respect to the theoretical position. As a result, combustion is not optimal and this has an impact on fuel consumption.

What is proposed hereinafter is a method that makes it possible to determine the position of the engine with greater accuracy, not by modifying the target and/or the sensor but by taking into consideration the geometric tolerances in the engine.

FIG. 1 shows a first curve corresponding to the instantaneous torque exerted on the crankshaft of the engine concerned as a function of time. By integrating this curve, a magnitude is obtained that is indicative of an overall torque, or mean gas torque, exerted on the crankshaft.

What is proposed here is to measure a convolution integral of a function f that varies with the angular position of the engine and with the instantaneous torque exerted by the pistons on the crankshaft. Reference is made here to document FR3084114A1 (notably pages 5 to 8) for the theoretical calculations corresponding to the convolution integral.

The function f chosen here is also represented in FIG. 1. It is a function having a triangular profile centered on a top dead center position, in this instance for preference the top dead center position TDC1. This function has value 0 except in an interval about TDC1. Because top dead center corresponds to the passing of a tooth front, this interval begins one or two tooth front(s) before the top dead center position considered and ends respectively one or two tooth front(s) after this top dead center position. For example, if the teeth of the target are spaced at 15° from one another (N=24 above), f will adopt value 0 up until TDC1-15° C. RK and from TDC1+15° C. RK onwards, and between these two values will exhibit a triangular profile (isosceles triangle therefore exhibiting symmetry about TDC1).

If the result of the convolution integral is zero, namely if the mean gas torque over the interval is zero, then the triangle corresponding to the function f is indeed properly centered on TDC1 and therefore the value measured by the sensor corresponds to the theoretical value. There is then theoretically no correction to be made. To a first approximation, the value given by the sensor is correct.

If the result of the convolution integral is positive, this then means that the mean torque over the interval is positive and therefore that the triangle corresponding to the function f is offset (to the right in FIG. 1) with respect to the true dead center position. The measured value is too great and, to a first approximation, a negative correction needs to be made to the values measured by the sensor. Conversely, if the result of the convolution integral is negative, the triangle is offset to the left in FIG. 1 and, to a first approximation, a positive correction needs to be made to the measured values.

As becomes apparent from the description of document FR3084114A1, notably pages 5 and 6, the convolution integral mentioned above, namely the mean gas torque T over the interval considered, may be written in the form:

$$T = k * RPM \hat{} 3 * ( d 0 - d 1 )$$

where:
k is a constant
RPM is the rotational speed of the engine
RPM\hat{ }3 is the cube of the rotational speed of the engine
d0 is the duration of passage of the tooth preceding the top dead center position considered
d1 is the duration of passage of the tooth following the top dead center position considered.

The times do and d1 correspond to the times that elapse between two consecutive signals emitted by the position sensor. These times correspond to the times of passage between two successive falling tooth fronts. It is possible to envision a time of passage of two teeth or more, but for an angular separation of 15° between two teeth, the passage of one single tooth is sufficient. What is necessary here is for do and d1 to correspond to the one same rotation of the crankshaft.

This first measurement already allows a correction to be made to the measured angular-position value. However, this correction does not take into consideration any deficiencies in the geometry of the target itself. Specifically, if the angular separation between two successive tooth fronts is not identical, than the corrective measure proposed above cannot be taken into consideration. Therefore in order also to take into consideration the geometry of the target, it is proposed that a measurement be taken again, employing the same tooth fronts but without the influence of a combustion event.

FIG. 1 thus illustrates a second triangle, similar to the first, but offset by 360° C. RK. Here, the second measurement is not influenced (or is influenced very little) by a combustion event. A convolution integral is calculated and it is proposed that the result obtained for this second convolution integral be subtracted from the result obtained with the first convolution integral. This difference corresponds to a torque that reflects an offset between the theoretical position and the true position of the top dead center position (in this instance TDC1) that is being studied, but which is not influenced by the geometry of the target.

d(n−1) is the term used here for the time of passage of the tooth before the tooth corresponding to the top dead center position considered during the revolution that follows the passing of this top dead center position, and dn is the term used here for the time of passage of the tooth after the tooth corresponding to the top dead center position considered during the revolution that follows the passing of this top dead center position. The time of passage corresponds here to the time separating the emission of two signals by the position sensor at the passing of the tooth fronts that are to be considered. The time of passage of a tooth therefore corresponds to the time separating the emission of two successive signals. The triangular profile used is the same here as that used at the top dead center position considered.

As mentioned, the difference between the two convolution integrals corresponds to a torque, hereinafter referred to as corrected torque TC, given by the formula:

TC=k*RPM\hat{ }3*(d0−d1+dn−d(n−1))

It is assumed here that the times di correspond to the passage of a tooth, namely to an angle of 15° C. RK (give or take the manufacturing tolerance on the target), but it might be possible to consider another number of teeth and/or another angle of rotation.

There are preferential conditions for measuring the correction to be applied to the angular-position result supplied by the engine-position sensor.

Note that it is times of passage of teeth that are measured. As a result, greater accuracy is achieved when the engine speed is not very high.

In order not to falsify the measurement, it is preferable to avoid having any “parasitic” torques acting on the crankshaft. Thus, it is appropriate to give preference to taking measurements when the load applied to the engine is light. It is thus preferable to take measurements at low idle, preferably when the engine is uncoupled from its associated transmission means.

The moving parts of the engine also themselves exert an action (torque) on the crankshaft. The piston and the connecting rod corresponding to the cylinder concerned have a negligible influence compared with the combustion and also during the passage through top dead center for the exhaust stroke (or crossover), the deflection angle, and therefore the lever arm, is small and so the torque is therefore likewise small. The other moving masses, notably other piston(s) and connecting rod(s), have masses that are constant and therefore an influence which, on the one hand, is unvarying and, on the other hand, controllable.

In conclusion, the corrective measure is preferably performed at low idle, ideally with the engine uncoupled from its transmission.

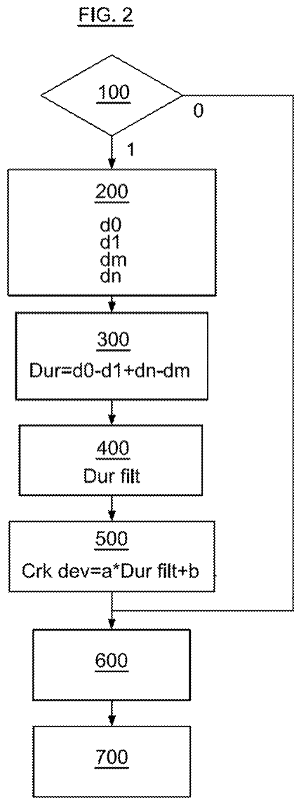

FIG. 2 summarizes the determination method that has just been described.

A first step 100 consists in determining whether the engine is under good conditions for taking the measurement, which is to say that this step consists in verifying that the engine is at low idle.

If the engine is low idle (case 1), the method passes to a step 200 described hereinbelow, otherwise (case 0) the method passes to a step 600 described later on.

Step 200 consists in measuring the times of passage of teeth. Consider again for example the nonlimiting embodiment in which, in theory, a (for example falling) tooth front corresponds to a piston passing through its combustion top dead center position. do is then measured which corresponds to the time elapsed between the passing of the previous (falling) tooth front and the passing of the tooth front corresponding to the combustion top dead center position considered. It would be possible here to envision a longer interval which instead of corresponding here to the passing of one tooth might correspond to the passing of two or three teeth (or theoretically potentially more). In this instance, a time corresponding to the same number of teeth needs to be measured each time.

During the course of step 200, the time d1 is also measured, this corresponding to the time elapsed between the passing of the tooth front corresponding to the combustion top dead center position and the passing of the next tooth front. Next, the same values are measured but with an offset of 360°, namely the passing of the same teeth one revolution later on, therefore corresponding to the passing of the piston in the cylinder concerned through the exhaust top dead center position, also referred to as the crossover top dead center position. Thus dm (which corresponds to d(n−1) above) and dn are measured.

Once all of these values have been acquired, a step 300 provides for calculating a duration Dur using the formula:

Dur=d0−d1+dn−dm.

A plurality of measurements of Dur are made and the values obtained are filtered during a step 400 in order to obtain a filtered value Dur_filt.

A corrective value Crk_dev to be applied to the position measurements taken by the position sensor detecting the passing of the (falling) tooth fronts is obtained (step 500) using an affine function with Dur_filt as a variable, which is to say that:

Crk_dev=a*Dur_filt+b

where a and b are constants dependent on the engine type and which can therefore be calibrated once and for all on a test engine.

The corrective value Crk_dev is then applied subsequently to any position measurement made by the position sensor (step 600).

It is possible in the present method to envision, as an option, a step 700 aimed at causing an alert to appear when the value of Crk_dev falls outside a predefined interval.

This method is particularly well suited to four-stroke engines with an uneven number of cylinders or else engines with an even number of cylinders but in which the combustion events are not evenly distributed over 720° C. RK (such as, for example, a two-cylinder V-engine). In the other instances, which is to say in engines in which each time there is a combustion event in one cylinder there is another combustion event in another cylinder one revolution (namely 360° C. RK) later, a slightly different strategy is proposed.

Measuring do and d1 as above first of all is proposed. It is then proposed that the measurements of d0 and d1 be repeated but at a high engine speed, namely a speed above a predefined speed, preferably at light load, for example during deceleration.

Each time here do is compared with d1. However, rather than calculating the difference between the two time measurements, what is proposed is to calculate the ratio of do to d1.

The ratio do/d1 when the engine is at low idle, for example in the conditions defined in step 100 (low engine speed, namely a speed lower than a predetermined speed and light load), is then termed Ratio_IS.

The ratio d0/d1 of the times do and d1 measured at high engine speed and preferably at light load is termed Ratio_HighRPM.

Of course, the values of Ratio_IS and Ratio_HighRPM are preferably filtered and it is subsequently the filtered values of these ratios that are used.

Logically, if the combustion top dead center position considered does indeed correspond with the passing of the corresponding tooth front, the difference between do and d1 varies as a result of the difference in rotational speed, but the ratio d0/d1 is insensitive to the rotational speed of the engine. Thus, if:
Ratio_IS=Ratio_HighRPM or else
Ratio_IS/Ratio_HighRPM=1 (which is equivalent)
there is no compensation to be made to the engine-position measurement.

By contrast, if the opposite is true, then a compensation will need to be made. If the ratio
Ratio_IS/Ratio_HighRPM>1
then provision is made to make a positive compensation, whereas if:
Ratio_IS/Ratio_HighRPM<1
provision is made to make a negative compensation.

Here again, depending on the ratio Ratio_IS/Ratio_HighRPM and the engine type, a preestablished table makes it possible to determine what compensation is to be made.

In summary, it is possible to determine the angular position of an internal combustion engine by measuring said position in the conventional way, namely with a target and an associated sensor, and then applying a compensation to the measured value. In a manner that is novel, this compensation is determined using the measurements made by the position sensor without using any other sensor or component. The position sensor detects the passing of tooth fronts on the target. As is known, the time between two successive passings of a tooth front is measured so as to be able to determine the rotational speed of the engine, this speed being an important item of data in regulating the engine.

Engines are usually designed so that the top dead center position of one cylinder corresponds as exactly as possible with a passing of a tooth front past the position sensor because this top dead center position is a reference position, notably for combustion. What is of interest here is the time of passage of the (or of two or three) tooth (teeth) before the passage through a predetermined combustion top dead center position being considered and the time of passage of the (or of two or three) tooth (teeth). It is the same number of teeth before and after the combustion top dead center position concerned that is considered.

The time-of-passage measurements are made under predetermined conditions, preferably when the engine is not under load such that its rotation is not disturbed by external loads exerting resistive torque on the engine crankshaft. Without external load, the measurements are not influenced by parasitic torques that cannot be taken into consideration because they are unknown.

Combustion top dead center is a very particular measurement point because great variations in torque occur when the engine is in such an angular position. This is therefore an advantageous point at which to take measurements. By comparing the time of passage of a tooth (or n teeth) needed to reach this combustion top dead center position with the time of passage of a tooth (or respectively of n teeth) after this top dead center position, it is possible to determine whether the combustion top dead center position is correctly centered with respect to the measurements made and therefore whether or not the true combustion top dead center position is offset from the theoretical top dead center position that corresponds to a measurement point. On the basis of the time difference observed, a correction will or will not, to a first approximation, be necessary.

This first difference in time-of-passage makes it possible to take account of defective positioning of the sensor with respect to the target, but will be unable to spot a defect associated with the target. In order to take such defects into consideration, optionally and as a preference, another measurement is taken using the same teeth but under different torque conditions and the results of the second measurement are subtracted from those of the first measurement (or vice versa) so that the influences that geometric defects have on the measurements cancel out.

### INDUSTRIAL APPLICATION

The present technical solutions may notably find application in engine control for improving the accuracy of this control.

The proposed method, and the corresponding means for implementing this method, allow for better determination of the true angular position of the engine. It then becomes possible to reduce the margins when adjusting the ignition angle (on a controlled-ignition engine) and thus optimize the fuel consumption.

The proposed solution makes it possible to relax the constraints on mechanical adjustment in the positioning of the target with respect to the sensor because the positioning errors are corrected. As a result, mechanical assembly is simplified, this in turn limiting assembly times and therefore production costs.

For engine control, it is now possible to compensate measurements taken, such as the capture of engine pressure, control of ignition angle (better match with torque), control of injection angle (for direct-injection engines including diesel engines), etc.

As an option, it is also possible to alert a user (or the after-sales department) if offsets outside of a predetermined range are detected.

The calculations proposed are very simple to perform in an electronic unit and already provide very good results even when the time measurements are not taken with great precision. The field of application of the method proposed in the present disclosure extends, in addition to applications to automobiles and to two-wheeled or three-wheeled vehicles, also to non-automobile applications and notably to small engines such as, for example, single-cylinder four-stroke engines, irregular two-cylinder V-engines, three-cylinder engines, irregular four-cylinder engines, etc. However, as mentioned, a variant embodiment is suitable for all engines, two-stroke or four-stroke.

The present disclosure is not limited to the proposed embodiments and to the variants described above, which are provided solely by way of example, but it encompasses all the variants that could be contemplated by a person skilled in the art within the scope of the intended protection.

1. A method for determining the angular position of an internal combustion engine, wherein a measurement of the angular position is made using a target comprising at its periphery uniformly spaced teeth with one singularity and which is associated with a sensor that detects the passage of a tooth front for each tooth, a passage past a tooth front theoretically corresponding in the engine to the passing of a predetermined piston through a top dead center position at the end of the compression stroke in a corresponding cylinder, said tooth front being referred to hereinafter as a combustion tooth front,
the method comprising:
detection of a first predetermined mode of operation of the engine (100);
measurement of a first time elapsed between the passing past the sensor of a tooth front that passes before the combustion tooth front, and that is referred to as earlier tooth front, and of the combustion tooth front (200);
measurement of a second time elapsed between the passing past the sensor of the combustion tooth front and of a tooth front that passes after the combustion tooth front and that is referred to as a later tooth front, the later tooth front being symmetrical with the earlier tooth front about the combustion tooth front (200);
comparison of the first time with the second time, these two times being theoretically equal if the combustion tooth front passes past the sensor when the predetermined piston is passing through its top dead center position at the end of the compression stroke (300); the comparison between the first time and the second time corresponding to a difference (300), and the value of the difference being filtered in order to yield a filtered difference (400), and
determination of a first corrective term for the angular position measurement measured by the sensor on the basis of the result of the comparison between the first time and the second time according to a predetermined formula corresponding to an engine type (500), the first corrective term corresponding to an affine function of the filtered difference,
determination of the angular position of the engine by applying the determined first corrective term to the angular position measurement measured by the sensor.

2. The method as claimed in claim 1, wherein the first predetermined mode of operation of the engine corresponds to the engine operating at low idle.

3. The method as claimed in claim 1, wherein the earlier tooth front corresponds to the tooth front immediately preceding the combustion tooth front and the later tooth front corresponds to the tooth front immediately following the combustion tooth front.

4. The method for determining the angular position of an internal combustion engine as claimed in claim 1, wherein the engine is an irregular-ignition engine and in that the method further comprises:
measurement of a third time elapsed between the passing past the sensor of the tooth front that passes one revolution, namely 360°, after the earlier tooth front, and of the tooth front one revolution after the combustion tooth front;
measurement of a fourth time elapsed between the passing past the sensor of the tooth front that passes one revolution after the combustion tooth front and of the tooth front that passes one revolution after the later tooth front;
determination of a second corrective term for the angular position measurement measured by the sensor on the basis of the result of the comparison between the third time and the fourth time according to a predetermined formula corresponding to an engine type.

5. The method as claimed in claim 4, wherein the comparison between the third time and the fourth time corresponds to a difference, in that the value of the difference is filtered in order to yield a filtered difference, and in that the second corrective term corresponds to an affine function of the filtered difference.

6. The method for determining the angular position of an internal combustion engine as claimed in claim 1, wherein the comparison of the first time with the second time is a calculation of a first ratio corresponding to the ratio linking the second time and the first time;
and the method further comprises:
detection of a second predetermined mode of operation of the engine;
measurement of a third time elapsed between the passing past the sensor of a tooth front that passes before the combustion tooth front, and that is referred to as earlier tooth front, and of the combustion tooth front;
measurement of a fourth time elapsed between the passing past the sensor of the combustion tooth front and of a tooth front that passes after the combustion tooth front and that is referred to as a later tooth front, the later tooth front being symmetrical with the earlier tooth front about the combustion tooth front;
comparison of the third time with the fourth time by calculating a second ratio corresponding to the ratio linking the fourth time and the third time; and
determination of the first corrective term for the angular position measurement measured by the sensor on the basis of the ratio linking the first ratio and the second ratio according to a predetermined formula corresponding to an engine type.

7. The method as claimed in claim 6, wherein the second predetermined mode of operation of the engine corresponds to operation at high engine speed, which is to say an engine speed above a predetermined speed, and at light load, namely at a load lower than a predetermined load.

8. A computer program comprising instructions for implementing a method as claimed in claim 1 when this program is executed by a processor, notably an electronic control unit of an internal combustion engine.

9. A non-transitory computer-readable recording medium on which there is recorded a program for implementing a method as claimed in claim 1 when this program is executed by a processor, notably an electronic control unit of an internal combustion engine.
